(19) United States
(12) Patent Application Publication
(10) Pub. No.: US 2023/0049777 A1
(43) Pub. Date: Feb. 16, 2023

(54) DEVICES, SYSTEMS, VEHICLES, AND METHODS FOR COOLING ELECTRONICS

(71) Applicant: Rivian IP Holdings, LLC, Plymouth, MI (US)

(72) Inventor: Graham Lloyd Feltham, Garden City, MI (US)

(21) Appl. No.: 17/398,616

(22) Filed: Aug. 10, 2021

(51) Int. Cl. B60H 1/00

(52) U.S. Cl. CPC B60H 1/00871; B60H 1/00742; H02J 7/0042

(57) ABSTRACT

Various disclosed embodiments include illustrative devices, systems, vehicles, and methods. In an illustrative embodiment, a device includes a processor and a memory configured to store computer-executable instructions. The computer-executable instructions are configured to cause the processor to receive device cooling information, determine a cooling electronic device condition in response to the received device cooling information, and instruct application of a cooling function in response to the determined cooling electronic device condition.

### INTRODUCTION

The present disclosure relates to cooling personal electronic devices. The statements in this section merely provide background information related to the present disclosure and may not constitute prior art.

High temperatures may adversely affect personal electronic device performance and recharging. Certain environmental conditions, such as sunlight in a warm climate, may cause an increase in device temperature.

### BRIEF SUMMARY

Various disclosed embodiments include illustrative devices, systems, vehicles, and methods.

In an illustrative embodiment, a device includes a processor and a memory configured to store computer-executable instructions. The computer-executable instructions are configured to cause the processor to receive device cooling information, determine a cooling electronic device condition in response to the received device cooling information, and instruct application of a cooling function in response to the determined cooling electronic device condition.

In another illustrative embodiment, a system includes a component, a cooling system, a processor, and a memory configured to store computer-executable instructions. The component is configured to generate device cooling information. The processor is in signal communication with the component and the cooling system. The computer-executable instructions are configured to cause the processor to receive device cooling information, determine a cooling electronic device condition in response to the received device cooling information, and instruct application of a cooling function in response to the determined cooling electronic device condition.

In another illustrative embodiment, a vehicle includes a component, a cooling system, a processor, and a memory configured to store computer-executable instructions. The component is configured to generate device cooling information. The processor in signal communication with the component and the cooling system. The computer-executable instructions are configured to cause the processor to receive device cooling information, determine a cooling electronic device condition in response to the received device cooling information, and instruct application of a cooling function in response to the determined cooling electronic device condition.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1 is an illustration in partial schematic form of an illustrative vehicle in a device cooling configuration.

FIG. 2 is a block diagram of illustrative components used in device cooling within a vehicle.

FIG. 3 is an illustration of a perspective view of an interior of a vehicle in a first device cooling scenario.

FIG. 4 is an illustration of a perspective view of an interior of a vehicle in a second device cooling scenario.

FIG. 5 is a flow diagram of an illustrative method for cooling electronic devices within a vehicle.

Like reference symbols in the various drawings generally indicate like elements.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Various disclosed embodiments include illustrative devices, systems, vehicles, and methods. As will be explained below, such embodiments can control personal electronic device cooling events and may help contribute to improving personal electronic device operations.

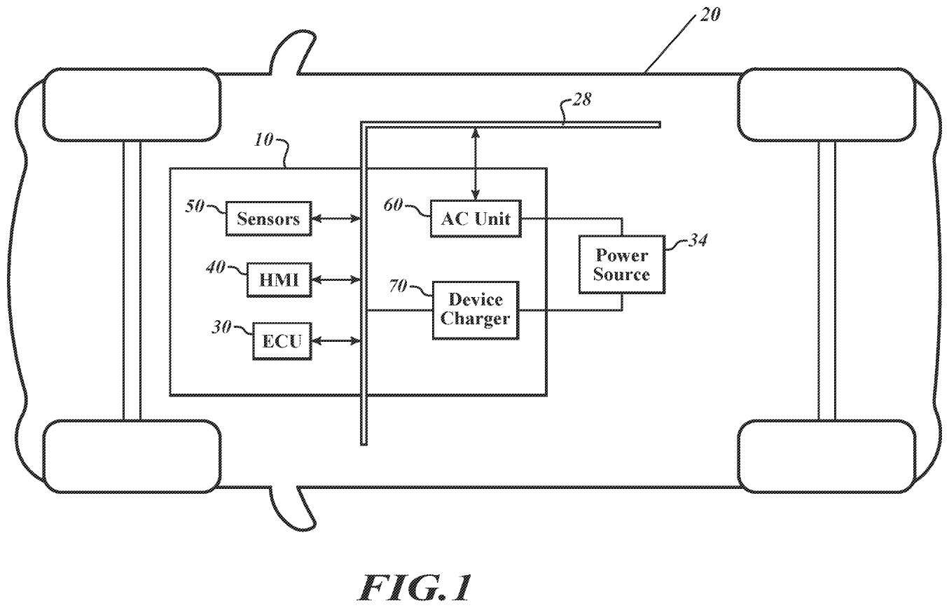

Referring now to FIG. 1, in various embodiments an illustrative vehicle 20 includes a system 10 for providing cooling of a personal electronic device(s). In various embodiments the vehicle 20 may be an automobile, a train, an aircraft, a boat, or any device having an enclosed space capable of experiencing large temperature changes and having at least a controllable cooling system. The vehicle 20 includes a power source 34 and the system 10, which includes an electronics control unit (ECU) 30, an air conditioning (AC) unit 60, a human-machine interface (HMI) 40, a sensor(s) 50, and a personal device charger(s) 70, all of which will be described in more detail below.

In various embodiments and given by way of example only and not of limitation, the power source 34 may include a device configured to generate electrical power for use by the other components of the vehicle 20. The power source 34 may be an electric motor, an internal combustion motor, a battery pack, or comparable power creating devices. The battery pack may suitably include high energy rechargeable batteries that store electrical charge and discharge electrical current upon request. The battery pack may be structured in any desirable form, such as without limitation cylindrical, pouch, prismatic, massless, or other comparable forms. Generally, the battery pack includes Li-ion batteries, such as without limitation Nickel Cobalt Aluminum batteries, Lithium Manganese Cobalt batteries, or Lithium Manganese Oxide batteries. However, other materials may be used for providing comparable recharging, energy density, and energy discharge capabilities.

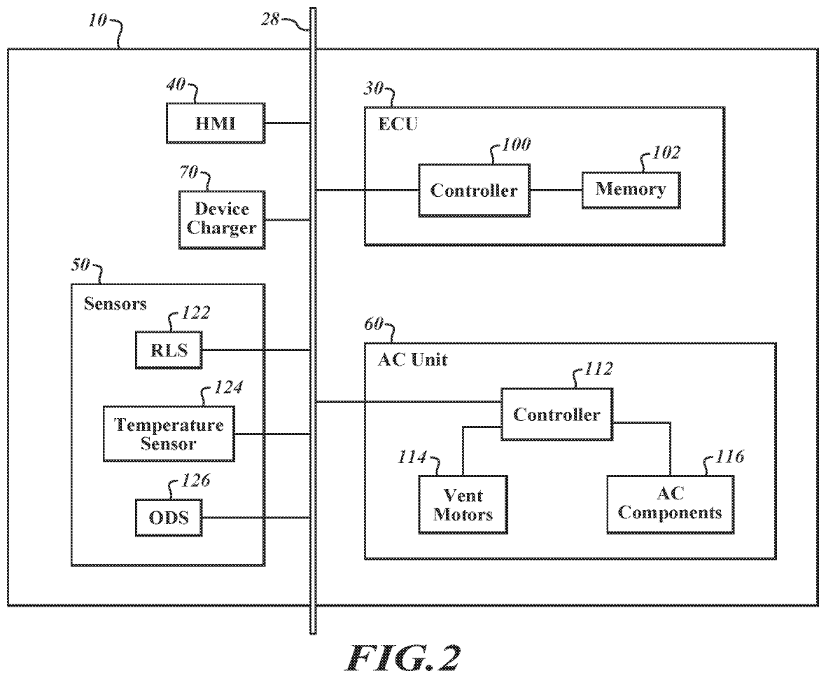

Referring additionally to FIG. 2, the sensor(s) 50 may include a rain light sensor (RLS) 122, a temperature sensor 124, and an occupancy detection sensor (ODS) 126. In various embodiments the ECU 30 may include a controller 100 and a memory 102. In various embodiments the AC unit 60 may include a controller 112, one or more ventilation motors/actuators 114 and AC components 116. The controller unit 100 communicates with the device charger 70, the HMI 40, the sensor(s) 50, and the AC unit 60. The memory 102 stores computer-executable instructions configured to cause the controller 100 to receive device cooling information, determine a cooling electronic device condition in response to the received device cooling information, and instruct application of a cooling function in response to the determined cooling electronic device condition. The instruction of application of the cooling function may include a number of instructions for controlling operation of components of the AC unit 60. The instructions may include or cause the controller 112 to generate a vent control signal. The vent control signal may cause the controller 112 to control airflow to vents within the vehicle 10 or may include targeted louvre vent directional control information. If the targeted louvre vent directional control information may include a vent address signal and directional control signal(s).

In various embodiments device cooling information may include location information of the personal electronics device, presence information, environmental information. Sources of the device cooling information will be described in more detail below. The location information may be communicated by the personal electronics device to the controller 100 via a wired or a wireless connection with the HMI 40.

In various embodiments the ECU 30 and the AC unit 60, may communicate with each other and with numerous other vehicle components via a peer-to-peer network bus 28, such as a controller area network (CAN) bus. Other peer-to-peer network buses, such as a local area network (LAN), a wide area network (WAN), or a value-added network (VAN), may also be used for enabling communication between the components connected to the peer-to-peer network. The AC unit 60 and the ECU 30 may communicate via the network bus 28 with the HMI 40; the device charger 70; numerous sensors 50 including the RLS 122, the temperature sensor 124, and the ODS 126; and each other.

In various embodiments and given by way of example only and not of limitation, the HMI 40 may include mechanical buttons, switches, voice recognition capabilities, gesture recognition capabilities, or may include selectable graphical user interface features presented on a vehicle display device(s) or via an application program executable by a person electronic device. The HMI 40 allows a vehicle operator to select a device cooling operational mode.

In various embodiments the computer-executable instructions are configured to cause the controller 100 to determine that a personal electronic device is present in response to information received from the device charger 70. The controller 100 may determine a temperature and/or a sunlight value received from the RLS 122 and/or the temperature sensor 124 or may receive condition information, such as temperature, from wired or wireless communication with the personal electronic device. The controller 100 determines a cooling event should begin in response to the information received from the device charger 70 indicating presence of a personal electronic device, location of the personal electronic device, and the determined temperature value and/or sunlight value (environmental information) being above a threshold value. The controller 100 determines a stop cooling electronic device condition in response to the environmental value being below a threshold value, such as sunlight below a predefined luminescence value and/or the temperature below a predefined temperature value. Additionally or alternatively, the controller 100 determines a stop cooling electronic device condition in response to the temperature value received from the personal electronics device being below a threshold value, thus indicating that the personal electronics device has been adequately cooled. Additionally or alternatively, the controller 100 may determine a stop cooling electronic device condition in response to the location information indicating the personal electronics device is no longer in the vehicle 10 or not in a location of the vehicle to be affected by a cooling operation. The controller 100 instructs application of the cooling function to stop in response to the determined stop cooling electronic device condition.

In various embodiments the computer-executable instructions are configured to cause the controller 100 to begin the cooling event in response to receiving a cooling request from the HMI 40.

In various embodiments and given by way of example only and not of limitation, the ventilation motors/actuators 114 may include linear and/or rotational electric, hydraulic, or pneumatic actuators, or comparable devices capable of moving air deflection devices, such as, without limitation, vent louvers, located at ventilation exit ports within the vehicle 20 and vent dampers or louvers located within the ventilation system. Motors and actuators for controlling louvers are well known in the art and no further explanation is necessary for a person of skill in the art to understand disclosed subject matter. The vent and associated ventilation motors/actuators 114 may be uniquely identifiable by an address. Thus, the vent control signals may include a vent address and directional control signals. In various embodiments, a vent includes multiple ventilation motors/actuators 114, such as, without limitation, for controlling vertical louvers and horizontal louvres, and thus the directional control signals may include multiple directional control signals. For a two motor controlled vent the directional control signals may include a first direction (vertical) control signal and a second direction (horizontal) control signal.

In various embodiments and given by way of example only and not of limitation, the device charger 70 may include a shelf or other mechanisms for holding a personal electric device(s). The device charger 70 may include a wired or wireless charging components. In a wired configuration, the device charger 70 may include a charging cord configured to receive a charging cable connectable to the personal electronic device. In a wireless configuration, the device charger 70 includes components located below the surface where the personal electronic device sits. The components of the device charger 70 may provide tightly-coupled electromagnetic inductive (non-radioactive) charging or loosely-coupled electromagnetic resonance (radioactive) charging. Other wireless charging methods may be used, such as without limitation uncoupled radiofrequency charging that provides a trickle charge. Wireless charging devices are well known in the art and no further explanation is necessary for a person of skill in the art to understand disclosed subject matter.

In various embodiments the system 10 may include a storage location, similar to the shelf included with the device charger 70, for holding the personal electronic device. The storage location may be susceptible to increased heating due to many factors, such as direct sunlight.

In various embodiments and given by way of example only and not of limitation, the occupant detection sensor 42 may be a device that is capable of sensing an electrical value, such as, without limitation, resistance, capacitance, or current. A seat occupied signal is generated in response to the sensed electrical value reaching a threshold value. Occupant detection sensor/switches are well known in the art and no further explanation is necessary for a person of skill in the art to understand disclosed subject matter.

In various embodiments and given by way of example only and not of limitation, the AC components 116 may include a compressor, a fan, a condenser, an expansion valve, a drier, and an evaporator/blower. AC systems and their components are well known in the art and no further explanation is necessary for a person of skill in the art to understand disclosed subject matter.

In various embodiments given by way of example only and not of limitation, the temperature sensor 124 may include thermal couplers, resistance temperature detectors, thermistors, semiconductor-based integrated circuits, or comparable devices that can measure temperature changes. The RLS 122 may include an optical sensor capable of detecting sunlight above the threshold amount. An electronics device cooling condition may be initiated in response to the sensed temperature being above a temperature threshold value and/or the sensed amount of sunlight being greater than a light threshold value. RLS and temperature sensors are well known in the art and no further explanation is necessary for a person of skill in the art to understand disclosed subject matter.

It will be appreciated that the functions described herein for the ECU 30 and the AC unit 60 may be distributed between each other, to other data processing components of the vehicle 20, or to other devices that are in communication with components of the vehicle 20.

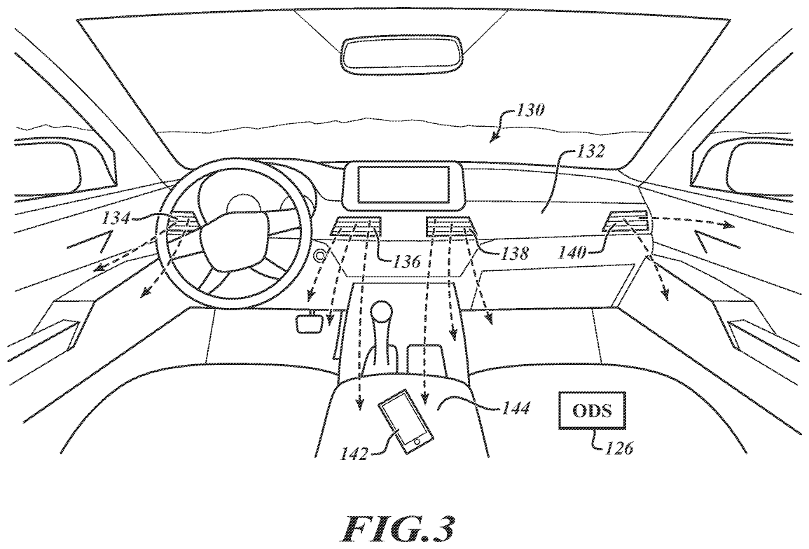

Referring additionally to FIG. 3, an illustration of a perspective view of a cabin 130 of a vehicle operating in a first device cooling scenario. The cabin 130 includes a dashboard 132 that includes a left vent 134, a center left vent 136, a center right vent 138, and a right vent 140. It can be appreciated to one of ordinary skill that vents are not limited to being in the dashboard 132, but may be located anywhere within the cabin 130, including vents that are incorporated into, or positioned adjacent to, a storage area where a personal device may be held. The vents 134, 136, 138, and 140 include actuator driven louvers (not shown) that are controllable for directing air generated by the AC unit 60 included within the vehicle. In some examples, air generated by the AC unit 60 may be directed by selectively opening and closing one or more dampers positioned within ducts of the AC unit 60. The cabin 130 includes a personal device charging station 144 located in a center console located between a driver-side and a passenger-side of the cabin 130. The personal charging station 144, which includes the device charger 70, is configured to receive a personal electronic device 142 and charge the personal electronic device 142 as needed. Seats within the cabin 130 may also include the ODS 126 configured to detect when a person is occupying the seat. In the scenario depicted, the ODS 126 detects a passenger in the passenger seat, then the actuators associated with the center left vent 136 and the center right vent 138 are commanded by the controller 100 or 112 to direct air at the personal device charging station 144 in response to a request from the HMI 40 or a determination that a cooling device condition exists. The cooling device condition may exist in response to device presence information received from the personal device charging station 144 and light or temperature information from the RLS 122 or the temperature sensor 124 located within the cabin 130 being above a predefined threshold value and/or temperature information received from the personal electronics device 142 being above a predefined threshold value. Also, in this scenario, the right vent 140 remains directed to the passenger detected in the passenger seat.

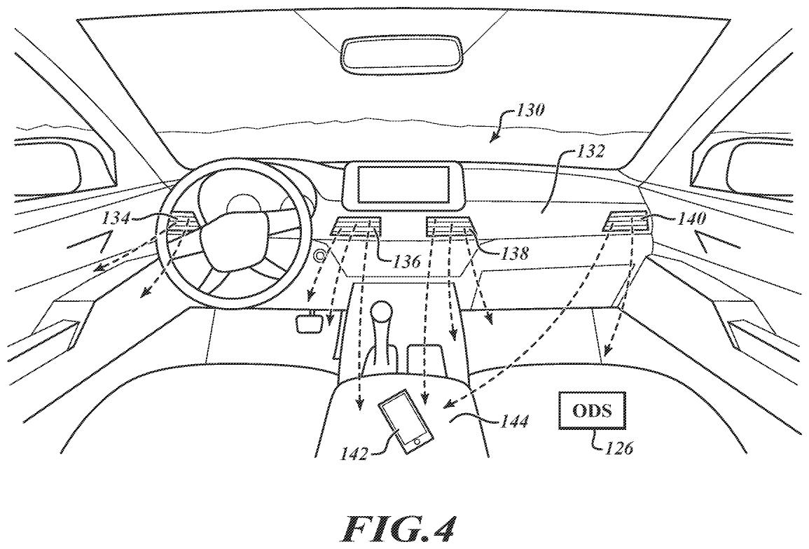

Referring additionally to FIG. 4, an illustration of a perspective view of the cabin 130 of the vehicle of FIG. 3 operating in a second device cooling scenario. In the scenario depicted, the ODS 126 does not detect an occupant of the passenger seat. Thus, the controller 100 or 112 determines that one or more of the passenger vents can be repurposed. In the scenario depicted, the actuators (not shown) associated with the center left vent 136, the center right vent 138, and the right vent 140 are commanded by the controller 100 or 112 to move louvers of the vents 136, 138, and 140 to direct air at the personal device charging station 144 in response to a device cooling request from the HMI 40 or a determination that a cooling device condition exists in response to device presence information received from the personal device charging station 144 and sunlight or temperature information from the RLS 122 or the temperature sensor 124 located within the cabin 130. In some examples, temperature information may be received from the personal electronic device 142, e.g., through a wired or wireless connection between the HMI 40 and the personal electronic device 142.

In another scenario, where the ODS 126 does not detect an occupant of the passenger seat, the controller 100 or 112 may, in addition to or alternative to controlling the louver actuators, reduce airflow of one or more of the vents to the passenger seat and increase airflow through vents which are directed toward the personal electronics device.

In various embodiments the vehicle 20 may include other types of cooling components connectable to an AC unit or an ECU. These other types of cooling components may include a Peltier device or a fluid (air or liquid) cooling ducts embedded into the personal device charging station 144. The controller 100 or 112 may control these other types of cooling components to provide cooling in response to a determined device cooling condition.

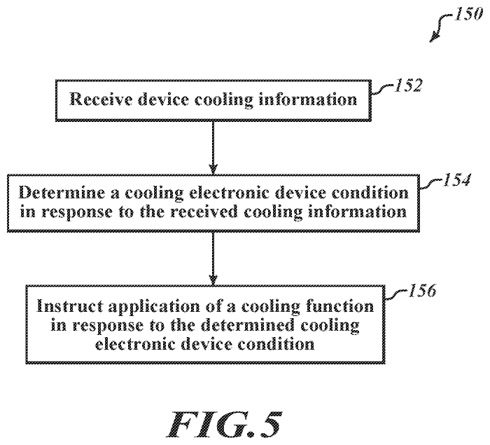

Referring additionally to FIG. 5, an illustrative process 150 may be performed for cooling personal electronics devices. At a block 152, the process 150 receives device cooling information. At a block 154, the process 150 determines a cooling electronic device condition in response to the received device cooling information. At a block 154, the process 150 instructs application of a cooling function in response to the determined cooling electronic device condition.

In some embodiments, a vent control signal is generated in response to the determined cooling electronic device condition and sent to a vent actuator.

In some embodiments, generating the vent control signal includes generating a target vent address, generating a first direction control signal, and generating a second direction control signal.

In some embodiments, receiving the device cooling information includes receiving location information for an electronic device, a user commanded cooling request, or an environmental value.

In some embodiments, a stop cooling electronic device condition is determined in response to the environmental value being below a threshold value. The application of the cooling air is instructed to stop in response to the determined stop cooling electronic device condition.

In some embodiments, receiving the device cooling information includes receiving device presence information.

Those skilled in the art will recognize that at least a portion of the ECU 30, the AC unit 60, the HMI 40, controllers, components, devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and application programs, one or more interactive devices (e.g., a touch pad, a touch screen, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

The term controller, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of controller (e.g., at a first time), as a second type of controller (e.g., at a second time, which may in some instances coincide with, overlap, or follow a first time), and/or as a third type of controller (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first controller that has a first purpose, then a second controller that has a second purpose and then, a third controller that has a third purpose, and so on. The transition of a reconfigurable and/or controllable component may occur in as little as a few nanoseconds, or may occur over a period of minutes, hours, or days.

In some such examples, at the time the controller is configured to carry out the second purpose, the controller may no longer be capable of carrying out that first purpose until it is reconfigured. A controller may switch between configurations as different components/modules in as little as a few nanoseconds. A controller may reconfigure on-the-fly, e.g., the reconfiguration of a controller from a first controller into a second controller may occur just as the second controller is needed. A controller may reconfigure in stages, e.g., portions of a first controller that are no longer needed may reconfigure into the second controller even before the first controller has finished its operation. Such reconfigurations may occur automatically, or may occur through prompting by an external source, whether that source is another component, an instruction, a signal, a condition, an external stimulus, or similar.

For example, a central processing unit or the like of a controller may, at various times, operate as a component/module for displaying graphics on a screen, a component/module for writing data to a storage medium, a component/module for receiving user input, and a component/module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple components/modules, the example includes the possibility that the same hardware may implement more than one of the recited components/modules, either contemporaneously or at discrete times or timings. The implementation of multiple components/modules, whether using more components/modules, fewer components/modules, or the same number of components/modules as the number of components/modules, is merely an implementation choice and does not generally affect the operation of the components/modules themselves. Accordingly, it should be understood that any recitation of multiple discrete components/modules in this disclosure includes implementations of those components/modules as any number of underlying components/modules, including, but not limited to, a single component/module that reconfigures itself over time to carry out the functions of multiple components/modules, and/or multiple components/modules that similarly reconfigure, and/or special purpose reconfigurable components/modules.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (for example “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software (e.g., a high-level computer program serving as a hardware specification), firmware, or virtually any to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software (e.g., a high-level computer program serving as a hardware specification) and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

What is claimed is:

1. A device comprising:
a processor; and
a memory configured to store computer-executable instructions configured to cause the processor to:
receive device cooling information;
determine a cooling electronic device condition in response to the received device cooling information; and
instruct application of a cooling function in response to the determined cooling electronic device condition.

2. The device of claim 1, wherein instructing application of the cooling function further includes:
generating a vent control signal in response to the determined cooling electronic device condition; and
sending the vent control signal to a vent actuator.

3. The device of claim 2, wherein the vent control signal includes:
a target vent address;
a first direction control signal; and
a second direction control signal.

4. The device of claim 1, wherein the device cooling information includes location information for an electronic device.

5. The device of claim 1, wherein the device cooling information includes device presence information.

6. The device of claim 1, wherein the device cooling information includes an environmental value.

7. The device of claim 6, wherein the memory is further configured to store computer-executable instructions configured to cause the processor to:
determine a stop cooling electronic device condition in response to the environmental value being below a threshold value; and
instruct application of the cooling function to stop in response to the determined stop cooling electronic device condition.

8. A system comprising:
a component configured to generate device cooling information;
a cooling system;
a processor in signal communication with the component and the cooling system; and
a memory configured to store computer-executable instructions configured to cause the processor to:
receive device cooling information;
determine a cooling electronic device condition in response to the received device cooling information; and
instruct application of a cooling function in response to the determined cooling electronic device condition.

9. The system of claim 8, wherein:
the cooling system includes:
a vent;
a first actuator of the vent;
a second actuator of the vent; and
an air conditioning system; and
the application instruction includes:
a first control signal configured to control the first actuator;
a second control signal configured to control the second actuator; and
a cooling control signal configured to control the air conditioning system.

10. The system of claim 8, wherein the component includes electronic device charging system, the device cooling information includes location information for an electronic device.

11. The system of claim 8, wherein the component includes electronic device charging system, the device cooling information includes device presence information.

12. The system of claim 8, wherein the component includes an environmental sensor, the device cooling information includes an environmental value.

13. The system of claim 12, wherein the memory is further configured to store computer-executable instructions configured to cause the processor to:
determine a stop cooling electronic device condition in response to the environmental value being below a threshold value; and
instruct application of the cooling function to stop in response to the determined stop cooling electronic device condition.

14. The system of claim 8, wherein:
the component includes an occupant detection sensor configured to detect presence of an occupant; and
the instructions are further configured to cause the processor to:
determine the cooling electronic device condition in response to the detected presence of the occupant.

15. A vehicle comprising:
a cabin disposed on a chassis;
a component configured to generate device cooling information;
a cooling system configured to apply cooling air into the cabin;
a processor in signal communication with the component and the cooling system; and
a memory configured to store computer-executable instructions configured to cause the processor to:
receive device cooling information;
determine a cooling electronic device condition in response to the received device cooling information; and
instruct application of a cooling function in response to the determined cooling electronic device condition.

16. The vehicle of claim 15, wherein:
the cooling system includes:
a vent;
a first actuator of the vent;
a second actuator of the vent; and
an air conditioning system; and
the application instruction includes:
a first control signal configured to control the first actuator;
a second control signal configured to control the second actuator; and
a cooling control signal configured to control the air conditioning system.

17. The vehicle of claim 16, wherein the component includes electronic device charging system, the device cooling information includes location information for an electronic device.

18. The vehicle of claim 16, wherein the component includes electronic device charging system, the device cooling information includes device presence information.

19. The vehicle of claim 16, wherein the component includes an environmental sensor, the device cooling information includes an environmental value.

20. The vehicle of claim 19, wherein the memory is further configured to store computer-executable instructions configured to cause the processor to:
determine a stop cooling electronic device condition in response to the environmental value being below a threshold value; and
instruct application of the cooling function to stop in response to the determined stop cooling electronic device condition.
